(19) United States
(12) Patent Application Publication
(10) Pub. No.: US 2005/0255895 A1
(43) Pub. Date: Nov. 17, 2005

(54) Adaptable charging cradle with speaker for portable communication devices

(75) Inventors: Yang-Jic Lee, Seoul (KR); Woo-Seok Lee, Gunpo-si (KR); Jong-Seong Lee, Seoul (KR); Beom-Ku Han, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,397

(22) Filed: Dec. 6, 2004

(30) Foreign Application Priority Data
May 17, 2004 (KR) 34607/2004

(51) Int. Cl. H04Q 7/20

(52) U.S. Cl. 455/573; 455/575.1

(57) ABSTRACT

Disclosed herein is an adaptable charging cradle with a speaker usable with a variety of types of portable communication devices. The charging cradle includes a cradle body having a box-shaped receiving space with a front and an upper end opened, at least one speaker unit mounted to the cradle body for emitting sound, and a replaceable sliding cradle housing having fitting means for fitting a portable communication device in the replaceable sliding cradle housing. The replaceable sliding cradle housing is slidably guided in the receiving space of the cradle body such that the portable communication device fitted in the cradle housing can be held in the cradle body. The charging cradle further comprises a connection member mounted to a predetermined position of the receiving space for charging the portable communication device fitted in the cradle housing and holding the cradle housing.

### PRIORITY

This application claims priority to an application entitled “ADAPTABLE CHARGING CRADLE WITH SPEAKER FOR PORTABLE COMMUNICATION DEVICES”, filed in the Korean Intellectual Property Office on May 17, 2004 and assigned Serial No. 2004-34607, the contents of which are incorporated herein by reference.

### BACKGROUND OF THE INVENTION

1. Field of the Invention

The present invention relates to a portable communication device including cellular phones, personal digital assistants, hand held personal computers, digital communication devices, MP3 phones, camera phones, TV phones, video phones, and game phones, and more particularly to an adaptable charging cradle with a speaker for portable communication devices.

2. Description of the Related Art

Generally, “portable communication devices” means electronic devices that are portable, and enable owners of the devices to communicate wirelessly Such portable communication devices have become increasingly small, slim, and lightweight, whereby portability thereof is improved. Furthermore, such portable communication devices are capable of multimedia transmission, whereby the devices provide various additional functions. Future portable communication devices are expected to be even more miniaturized, lightweight, multipurpose devices with various functions, and will be easily adaptable to various multimedia and Internet environments. The portable communication devices are electronic devices commonly used by people of all ages and both gender, worldwide, and are considered necessities of life.

On the basis of their form, portable communication devices may be classified into several types. For example, portable communication devices may be classified into a bar-type communication device, a flip-type communication device, or a folder-type communication device. The bar-type communication device has a bar-type single housing, the flip-type communication device comprises a bar-type housing and a flip part pivotably attached to the housing, and the folder-type communication device comprises a bar-type housing and a folder part pivotably attached to the housing.

On the basis of where or how the device is worn, the portable communication device may also be classified into a necklace-type communication device or a wrist-type communication device. The necklace-type communication device is worn on the neck of a user by means of a string, and the wrist-type communication device is worn on the wrist of the user.

On the basis of how the device is opened or closed, the portable communication device may be further classified into a rotating-type communication device or a sliding-type communication device. The rotating-type communication device is characterized in that two housings are rotatably connected, while the housings are continuously opposite to each other. The rotating-type communication device is opened/closed by rotation of the two housings about a common axis apart from/towards each other. On the other hand, the sliding-type communication device is characterized by the two housings sliding in a longitudinal direction. The sliding-type communication device is opened/closed by sliding the two housings apart from/towards each other. The above-mentioned various types of communication devices will be easily appreciated by a person of ordinary skill in the art to which the present invention pertains.

The portable communication devices have also been adapted to transmit/receive data at high speed in addition to performing an audio communication function. The portable communication devices use wireless communication technology for transmitting data at high speed, to satisfy the increasing desires of the consuming public.

Another increasing trend provides a camera lens in each portable communication device to transmit image signals. The portable communication device has a camera lens module mounted outside or inside a main body of the portable communication device so that a user of the device can talk with another user of a similar device while looking at each other, or can take pictures of desired subjects.

Conventional portable communication devices operate by means of electric power supplied from a battery pack mounted to the portable communication device. When battery power of the battery pack is fully consumed, the battery pack is recharged using an optional charging cradle. Generally, a portable communication device is sold together with a charging cradle that is exclusive to that portable communication device model, or to a limited number of models. Consequently, when a portable communication device is lost or broken, and thus a replacement communication device is purchased, or when a communication devices is to be replaced with a new communication device, it is naturally required that a corresponding new charging cradle must be bought. However, it is uneconomical to have to replace such existing charging cradles with new charging cradles.

Whenever a new portable communication device is bought or the existing portable communication device is replaced with a new portable communication device, it is necessary for a consumer to buy a new charging cradle exclusive to the newly brought or replaced portable communication device. Whenever a new portable communication device is developed, there is a need for development of an exclusive charging cradle. The associated economical loss imposes a heavy burden on the consumer. Consequently, there is a need for a novel charging cradle adaptable to various existing models of portable communication devices.

Further, users now watch movies or TV programs on conventional portable communication devices, or listen to music through conventional portable communication devices. These additional functions are performed in addition to performing audio communication, video communication, or Internet surfing. Consequently, it is necessary to provide a speaker to allow the user of the portable communication device to listen to sound outputted from the portable communication device more conveniently.

### SUMMARY OF THE INVENTION

Therefore, the present invention has been made in view of the above problem, and it is an object of the present invention to provide an adaptable charging cradle with a speaker applicable to various kinds of portable communication devices.

It is another object of the present invention to provide an adaptable charging cradle having a replaceable sliding cradle housing applicable to various kinds of portable communication devices and a speaker to provide loud stereophonic sound, thereby improving economic efficiency.

It is another object of the present invention to provide an adaptable charging cradle having a replaceable and rotatable sliding cradle housing applicable to various kinds of portable communication devices and a speaker to economically provide loud stereophonic sound, thereby improving economic efficiency and convenience of use.

It is another object of the present invention to provide an adaptable charging cradle with a speaker to maximize convenience of use.

It is yet another object of the present invention to provide an adaptable charging cradle with a speaker that is very economical, not only to consumers, but also to manufacturers.

In accordance with one aspect of the present invention, the above and other objects can be accomplished by the provision of an adaptable charging cradle for portable communication devices that includes a cradle body having a box-shaped receiving space with a front and an upper end opened; at least one speaker unit mounted to the cradle body for emitting sound; a replaceable sliding cradle housing having fitting means for fitting a portable communication device in the replaceable sliding cradle housing, the replaceable sliding cradle housing being slidably guided in the receiving space of the cradle body such that the portable communication device fitted in the cradle housing can be held in the cradle body; and a connection member mounted to a predetermined position of the receiving space for charging the portable communication device fitted in the cradle housing and holding the cradle housing.

In accordance with another aspect of the present invention, there is provided an adaptable charging cradle for portable communication devices that includes a cradle body having a box-shaped receiving space; at least one speaker housing attached to the cradle body for emitting sound; a supporting stand disposed in the receiving space of the cradle body such that the supporting stand can be rotated about a hinge axis extending in the direction where the speaker housing is attached to the cradle body, the supporting stand having first fitting means; a replaceable sliding cradle housing having a second rectangular fitting means for fitting a portable communication device in the replaceable sliding cradle housing, the cradle housing being slidably guided in the supporting stand such that the portable communication device fitted in the cradle housing can be held in the cradle body; and a connection member mounted to the supporting stand for charging the portable communication device fitted in the cradle housing and holding the cradle housing.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 to 3 are perspective views of an adaptable charging cradle according to a first preferred embodiment of the present invention respectively showing how a replaceable cradle housing is mounted to the charging cradle;

FIG. 4 is a perspective view of the charging cradle of FIG. 1 showing the cradle housing fully mounted to the charging cradle;

FIGS. 5 to 7 are perspective views of an interchangeable charging cradle according to a second preferred embodiment of the present invention respectively showing how a replaceable cradle housing is mounted to the charging cradle; and

FIG. 8 is a plan view of the charging cradle shown in FIG. 7.

### DETAILED DESCRIPTION OF THE PREFERRED EMBODIMENTS

Now, preferred embodiments of the present invention will be described in detail with reference to the accompanying drawings. In the following, a detailed description of known functions and configurations incorporated herein is omitted to avoid obscuring the subject matter of the present invention with unnecessary detail.

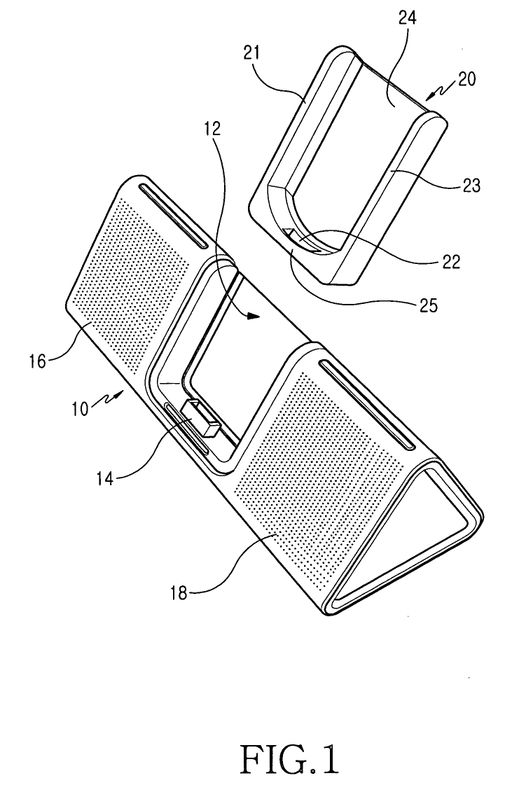

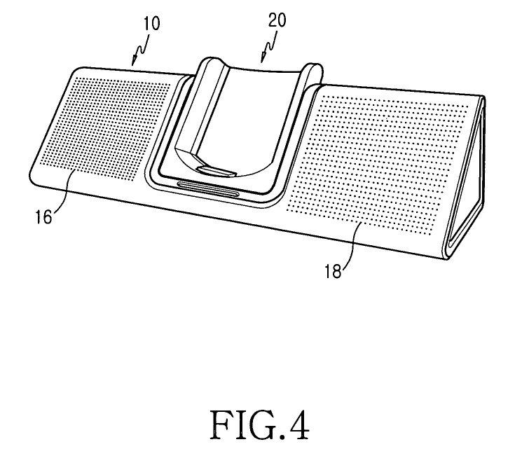

As shown in FIGS. 1 to 4, an adaptable charging cradle according to a first preferred embodiment of the present invention preferably includes a cradle body 10 formed in the shape of a triangle, the cradle body 10 having a box-shaped receiving space 12; speaker units 16 and 18 mounted at predetermined positions on the cradle body 10; a replaceable sliding cradle housing 20 having a box-shaped slot 24, the replaceable sliding cradle housing 20 being slidably guided in the receiving space 12 of the cradle body 10; and a connection member 14 mounted at a predetermined position of the receiving space 12 for charging a portable communication device fitted in the cradle housing 20 and for holding the cradle housing 20. The term “holding” means to secure the replaceable cradle housing 20 in place after the cradle housing 20 is fully slid down in the receiving space 12.

The cradle body 10 is preferably formed in the shape of a trigonal prism so that the cradle body 10 can be stably placed on a table or similar surface. The speaker units 16 and 18 mounted to the front part of the cradle part 10 emit loud stereophonic sound, as described by a user of the replaceable charging cradle. The portable communication device fitted in the replaceable cradle housing 20 of the adaptable charging cradle is disposed in such a manner that a display unit of the portable communication device faces the user of the adaptable charging cradle. Consequently, the user can conveniently and stably use the charging cradle and the portable communication device fitted in the charging cradle. The receiving space 12 is disposed at the center area of the front part of the cradle body 10. The other areas of the front part of the cradle body 10 are preferably wholly and continuously dedicated to provide a speaker function, and have a plurality of speaker holes for the speaker units 16 and 18. The speaker units 16 and 18 emit sound directed toward the front of the cradle body 10. Preferably, the speaker units 16 and 18 are symmetrically disposed at both sides of the receiving space 12 to emit stereophonic sound.

The square box-shaped slot 24 is provided at the replaceable sliding cradle housing 20 such that a portable communication device can be fitted in the slot 24. The slot 24 is a space where the portable communication device is fitted. The cradle housing 20 is held in the receiving space 12 of the cradle body 10 while the portable communication device fits in the slot 24 of the cradle housing 20. The cradle housing 20 has an open upper end, guiding sides 21 and 23, and a lower stop end 25 connected between the lower ends of the guiding sides 21 and 23. The portable communication device stably fits in the slot 24 of the cradle housing 20 by means of the guiding sides 21 and 23 and the lower stop end 25 of the cradle housing 20. At the lower stop end 25 of the cradle housing 20 is formed a through-hole 22, which communicates with the slot 24. Consequently, the connection member 14 is inserted through the through-hole 22 so that the connection member 14 can be connected to an interface connector of the portable communication device fitted in the slot 24 of the cradle housing 20.

Changing the shape of the slot 24 of the replaceable cradle housing 20 allow for, various kinds of portable communication devices to each be fitted in the cradle housing 20, which can be easily held in the cradle body 10, which is very economical to a consumer as well as a manufacturer. In other words, when various kinds of portable communication devices are provided together with various kinds of cradle housing 20 having slots suitable for the portable communication devices, any one of the portable communication devices can be stably held in the cradle body 10. Also, the receiving space 12 and the slot 24 are each formed in the shape of a box with the front and the upper end opened. Consequently, the replaceable cradle housing 20 can be inserted into the receiving space 12 of the cradle body 10 from the front or the upper end of the receiving space 12.

The receiving space 12 is disposed at the cradle body 10 while being inclined to the cradle body 10, and thus the cradle housing 20 is held in the receiving space 12 of the cradle body 10 while being inclined to the cradle body 10. As a result, the portable communication device fitted in the slot 24 of the cradle housing 20 is also held in the cradle body 10 while being inclined to the cradle body 10.

The connection member 14 is electrically connected to the portable communication device held in the cradle body 10 so that the portable communication device can be charged. When the portable communication device is operated in a MP3 mode, a user can listen to music through the speaker units 16 and 18. Also, the user can perform audio or video communication with another user of a similar communication device via the displayed screen. The portable communication device held in the replaceable charging cradle is not shown in the drawings.

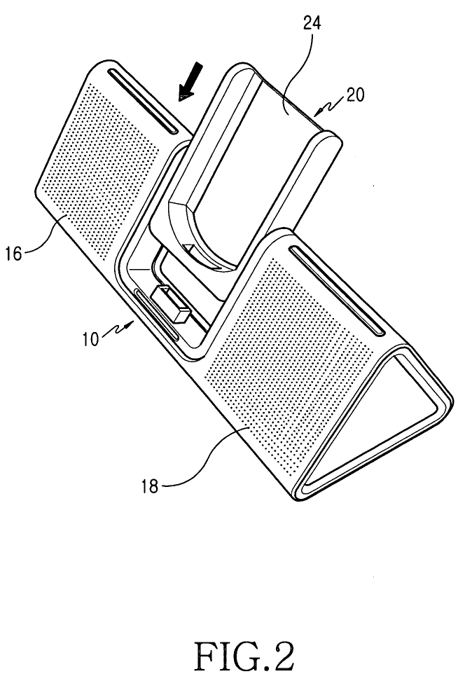

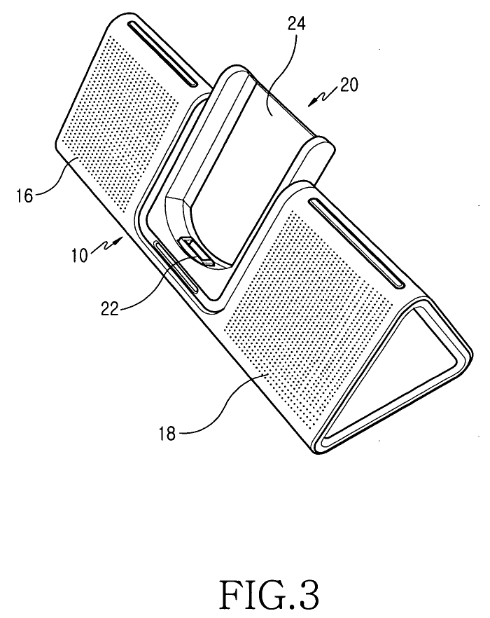

FIG. 1 shows the replaceable cradle housing 20 completely separated from the receiving space 12 of the cradle body 10, FIG. 2 shows the cradle housing 20 sliding down into the receiving space 12 of the cradle body 10, and FIG. 3 shows the cradle housing 20 completely held in the receiving space 12 of the cradle body 10.

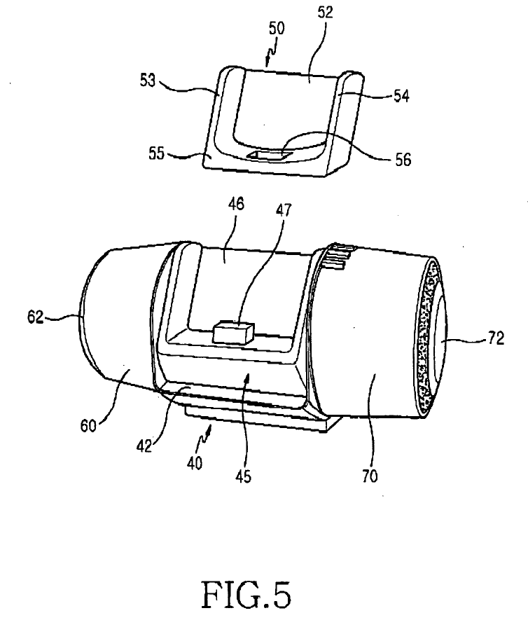

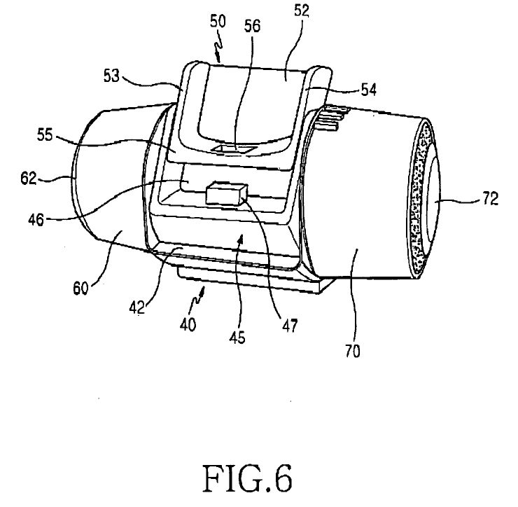

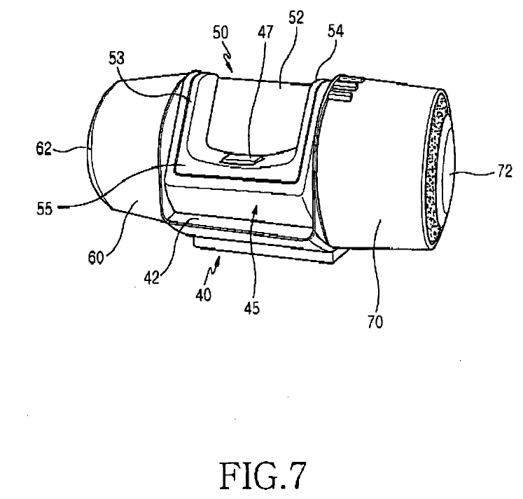

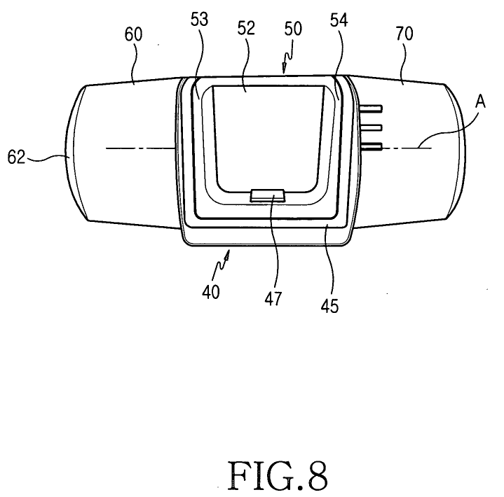

FIGS. 5 to 8 show an adaptable charging cradle according to a second preferred embodiment of the present invention that is very similar to the charging cradle of the first preferred embodiment of the present invention, except that the charging cradle according to the second embodiment has a rotatable supporting stand for supporting a cradle housing, which is rotated to adjust a tilt angle of a portable communication device.

Specifically, the adaptable charging cradle according to the second preferred embodiment of the present invention includes a cradle body 40 having a receiving space 42; speaker housings 60 and 70 attached at predetermined positions to the cradle body 40 for emitting sound outwardly from both sides of the cradle body 40; a supporting stand 45 disposed in the receiving space 42 such that the supporting stand 45 can be rotated about a hinge axis A extending in the direction where the speaker housings 60 and 70 are attached to the cradle body 40, the supporting stand 45 having first rectangular fitting means 46; a replaceable sliding cradle housing 50 having a second box-shaped rectangular fitting means 52, the replaceable sliding cradle housing 50 being slidably guided in the supporting stand 45; and a connection member 47 mounted at a predetermined position an the supporting stand 45 for charging a portable communication device fitted in the cradle housing 50 and securely holding the cradle housing 50. Hereinafter, the first fitting means 46 is referred to as a first slot, and the second fitting means 52 is referred to as a second slot.

The supporting stand 45 and the speaker housings 60 and 70 are stably placed on a table by means of the cradle body 40.

The speaker housings 60 and 70 are each preferably formed in the shape of a truncated cone. The speaker housings 60 and 70 are symmetrically provided on both sides of the cradle body 40 to emit stereophonic sound outwardly from the outer sides of the speaker housing 60 and 70. A portable communication device (not shown) is held in the rotatable supporting stand 45 in such a manner that a display unit of the portable communication device faces a user of the adaptable charging cradle. Consequently, the user can conveniently and stably use the charging cradle and the portable communication device fitted in the charging cradle. To the outer sides of the speaker housings 60 and 70 are attached speaker units 62 and 72, respectively. At the outer sides of the speaker housings 60 and 70 are also continuously formed a plurality of speaker holes for the speaker units 62 and 72, respectively. Consequently, stereophonic sound is emitted outwardly from the speaker housing 60 and 70.

The receiving space 42 is formed at the cradle body 40 such that front, rear and upper parts of the receiving space 42 are open. Preferably, the speaker housings 60 and 70 are symmetrically attached to the cradle body 40 about the receiving space 42 so that stereophonic sound is emitted from the speaker unit 62 and 72 attached to the outer sides of the speaker housing 60 and 70. The first slot 46 is provided at the supporting stand 45. The replaceable sliding cradle housing 50 is slidably guided in the first slot 46. The connection member 47 is formed at an inner surface of the lower end of the supporting stand 45 while being protruded upward.

The second box-shaped slot 52 is provided at the cradle housing 50 such that the portable communication device can be fitted in the second slot 52. The second slot 52 provides a space where the portable communication device is fitted. The cradle housing 50 is held in the supporting stand 45 while the portable communication device is fitted in the second slot 52 of the cradle housing 50. At the lower end 55 of the cradle housing 50 is formed a through-hole 56, which communicates with the second slot 52. Consequently, the connection member 47 is inserted through the through-hole 56 so that the connection member 47 can be connected to an interface connector of the portable communication device fitted in the second slot 52 of the cradle housing 50. Changing only the shape of the second slot 52 of the replaceable cradle housing 50 allows, various kinds of portable communication devices to each fit in the cradle housing 50, which can be easily held in the cradle body 40, which is very economical.

The first and second slots 46 and 52 are each formed in the shape of a box with front and upper ends opened. Consequently, the cradle housing 50 can be inserted into the first slot 46 of the supporting stand 45 from the front or the upper end of the first slot 46. Also, the portable communication device can be slidably inserted into the second slot 52 of the cradle housing 50 from the front or the upper end of the second slot 52. The first slot 46 is formed at the supporting stand 45 with a predetermined orientation. As the supporting stand 45 is rotated, the tilt angle of the portable communication device held in the supporting stand 45 while being fitted in the cradle housing 50 is changed. The tilt angle of the portable communication device is easily and conveniently adjusted by a user of the portable communication device.

The connection member 47 is electrically connected to the portable communication device held in the supporting stand 45 so that the portable communication device can be charged. When the portable communication device is operated in the MP3 mode, the user can listen to music through the speaker units 62 and 72. Also, the user can perform audio or video communication with another user of a similar communication device via the displayed screen.

As apparent from the above description, the present invention provides a charging cradle for portable communication devices that can be simultaneously used as a speaker and a charger, as well as a cradle. Consequently, the present invention has the effect of optimising convenience of use. Furthermore, a cradle housing of the charging cradle is replaceable, thereby improving economic efficiency by providing a charging cradle that is effectively universally adaptable. Especially, the adaptable charging cradle of the present invention is very economical, not only to consumers, but also to manufacturers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An adaptable charging cradle for portable communication devices, comprising:
a cradle body having a box-shaped receiving space with a front and an open space formed in an upper end thereof;
at least one speaker unit mounted to the cradle body for emitting sound;
a replaceable sliding cradle housing having fitting means for fitting a portable communication device in the replaceable sliding cradle housing, the replaceable sliding cradle housing being slidably guided in the receiving space of the cradle body such that the portable communication device fitted in the cradle housing can be held in the cradle body; and
a connection member mounted in a predetermined position of the receiving space for charging the portable communication device fitted in the cradle housing and for holding the cradle housing.

2. The cradle as set forth in claim 1, wherein the cradle housing has guiding sides and a lower stop end connected between lower ends of the guiding sides to facilitate stability fitting the portable communication device can be stably fitted in the cradle housing, and the cradle housing is provided at the lower stop end thereof with a through-hole communicating with the fitting means so that the connection member is inserted through the through-hole, and is then connected to an interface connector of a portable communication device fitted in the fitting means of the cradle housing.

3. The cradle as set forth in claim 1, wherein the fitting means is a slot, and the slot is formed with a front and an upper end thereof opened such that the portable communication device can be easily and conveniently fitted in the slot.

4. The cradle as set forth in claim 1, wherein the at least one speaker unit comprises two speaker units symmetrically disposed at both sides of the receiving space of the cradle body for emitting stereophonic sound towards the front of the cradle body.

5. The cradle as set forth in claim 1, wherein the receiving space is disposed at the cradle body while being inclined to the cradle body such that the cradle housing can be held in the receiving space of the cradle body while being inclined to the cradle body.

6. An adaptable charging cradle for portable communication devices, comprising:
a cradle body having a box-shaped receiving space;
at least one speaker housing attached to the cradle body for emitting sound;
a supporting stand disposed in the receiving space of the cradle body such that the supporting stand can be rotated about a hinge axis extending in the direction where the at least one speaker housing is attached to the cradle body, the supporting stand having first fitting means;
a replaceable sliding cradle housing having a second rectangular fitting means for fitting a portable communication device in the replaceable sliding cradle housing, the cradle housing being slidably guided in the supporting stand such that the portable communication device fitted in the cradle housing can be held in the cradle body; and
a connection member mounted to the supporting stand for charging the portable communication device fitted in the cradle housing and holding the cradle housing.

7. The cradle as set forth in claim 6, wherein the at least one speaker housing comprises two speaker housings symmetrically disposed at both sides of the cradle body and each formed in the shape of a truncated cone, wherein the speaker housings are provided at the outer sides thereof with speaker units for emitting stereophonic sound outwardly from the speaker housings.

8. The cradle as set forth in claim 6, wherein the at least one speaker housing comprises two speaker housings symmetrically disposed at both sides of the cradle body while being formed in shapes suitable to emit stereophonic sound from the speaker units attached to the outer ends of corresponding speaker housings.

9. The cradle as set forth in claim 6, wherein the receiving space is formed with open front, rear and upper parts thereof, and the first and second slot are each formed with open front and upper ends thereof.

10. The cradle as set forth in claim 6, wherein the first fitting means comprises a first slot, and the second fitting means comprises a second slot.
